(19) United States
(12) Patent Application Publication
(10) Pub. No.: US 2010/0042670 A1
(43) Pub. Date: Feb. 18, 2010

(54) INTEGRATED DEVELOPMENT ENGINE FOR A CLOUD COMPUTING ENVIRONMENT

(75) Inventors: Chandra H. Kamalakantha, Plano, TX (US); Jeffrey L. Weiss, McKinney, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Electronic Data Systems Corporation, Plano, TX (US)

(21) Appl. No.: 12/191,046

(22) Filed: Aug. 13, 2008

(51) Int. Cl. G06F 15/177; G06F 15/16

(52) U.S. Cl. 709/203; 709/222; 709/204

(57) ABSTRACT

A data processing system comprising a processor and accessible memory, the data processing system implementing an integrated development engine configured to automatically create and provision a computing environment in a network cloud environment.

### TECHNICAL FIELD

The present disclosure is directed, in general, to cloud computing environments.

### BACKGROUND OF THE DISCLOSURE

Cloud computing means Internet (‘Cloud’) based development and use of computer technology (‘Computing’). It is a style of computing where IT-related capabilities are provided “as a service”, allowing users to access technology-enabled services “in the cloud” without knowledge of, expertise with, or control over the technology infrastructure that supports them. It is a general concept that incorporates software as a service, Web 2.0 and other recent, well-known technology trends, where the common theme is reliance on the Internet for satisfying the computing needs of the users.

The majority of cloud computing infrastructure currently consists of reliable services delivered through next-generation data centers that are built on compute and storage virtualization technologies. The services are accessible anywhere in the world, with The Cloud appearing as a single point of access for all the computing needs of consumers. Commercial offerings need to meet the quality of service requirements of customers and typically offer service level agreements.

Today's problems in cloud computing environments include a lack of a system that is process-driven to provision a cloud-based computing environment, and weak integration between the cloud computing environment and the traditional hosting environment. Another problem concerns the lack of a standardized development platform that exposes development tools and the platforms for developing and deploying in services in the cloud and integrating with traditional hosting environments. Niche Cloud providers tend to lock-in on technology and tools which are not widely adopted hence consumers are locked into specific cloud providers, making switching providers require a complete rewrite and significant cost.

### SUMMARY OF THE DISCLOSURE

A disclosed embodiment provides a data processing system comprising a processor and accessible memory, the data processing system implementing an integrated development engine configured to automatically create and provision a computing environment in a network cloud environment. In some embodiments, the integrated development engine interacts with a user via a graphical user interface to create applications for the network cloud environment. In some embodiments, the integrated development engine uses a markup language to define functions according to Expressions, Actions and Statements categories.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in accordance with a disclosed embodiment;

FIG. 2 shows a cloud computing environment in accordance with a disclosed embodiment; and

FIG. 3 depicts a Composite Application Framework.

### DETAILED DESCRIPTION

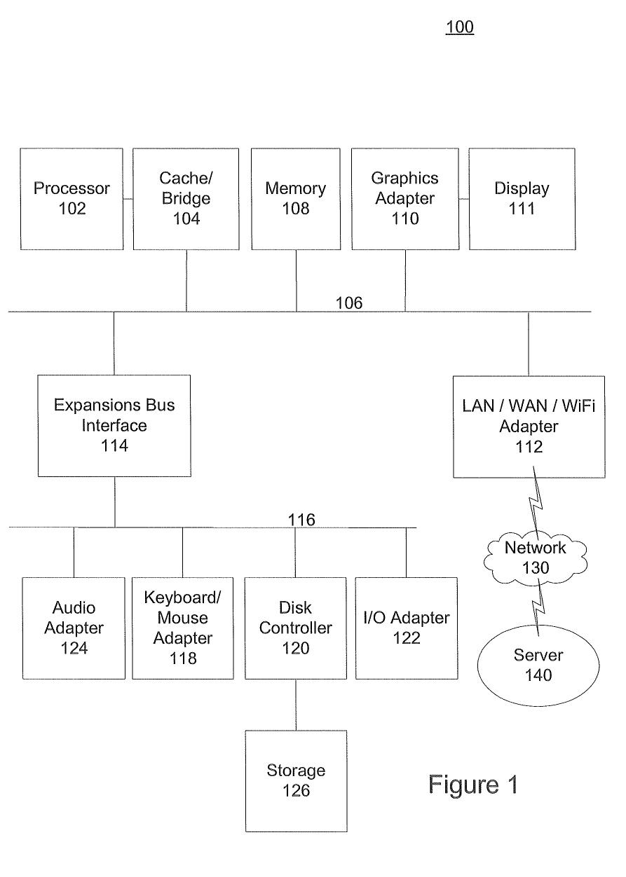

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include an Integrated Development Engine (IDE) that can automatically create and provision a computing environment in the cloud. Various disclosed embodiments provide an Integrated Development Engine (IDE) to develop applications that can be hosted and integrated to legacy environments. The IDE and the system can be implemented as described herein, and by using standard tools, e.g., XML. Security specifications can be captured and enforced using a Security Assertion Markup Language (SAML).

FIG. 1 depicts a block diagram of a data processing system in which an embodiment can be implemented as one of the data processing systems supporting and interacting with the cloud. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface (GUI). The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described. In other embodiments, the operating system provisioned can range from LINUX, SUN OS, Microsoft Windows, or others. The markup language used in some embodiments enables the system to be OS and machine independent during provisioning and runtime.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

The Integrated Development Engine (IDE) disclosed herein enables a set of actions, verbs, expressions, and configuration parameters to create and host custom applications in cloud computing environment. The IDE enables the developers to drag-and-drop actions/verbs/expressions/configuration parameters using a graphical user interface to create and host applications. The IDE interacts with a user via a graphical user interface to create applications for the network cloud environment. In some embodiments, the disclosed application itself includes a GUImade up of windows, forms, and controls, such as text fields, tabular forms, labels, etc. These controls are drag and drop capable as well. In some embodiments, the application can be rich or web forms. In specific embodiments, the application shows rich windows applications, and in some embodiments, the implementation could be implemented using JAVA Swing or MICROSOFT XAML techniques.

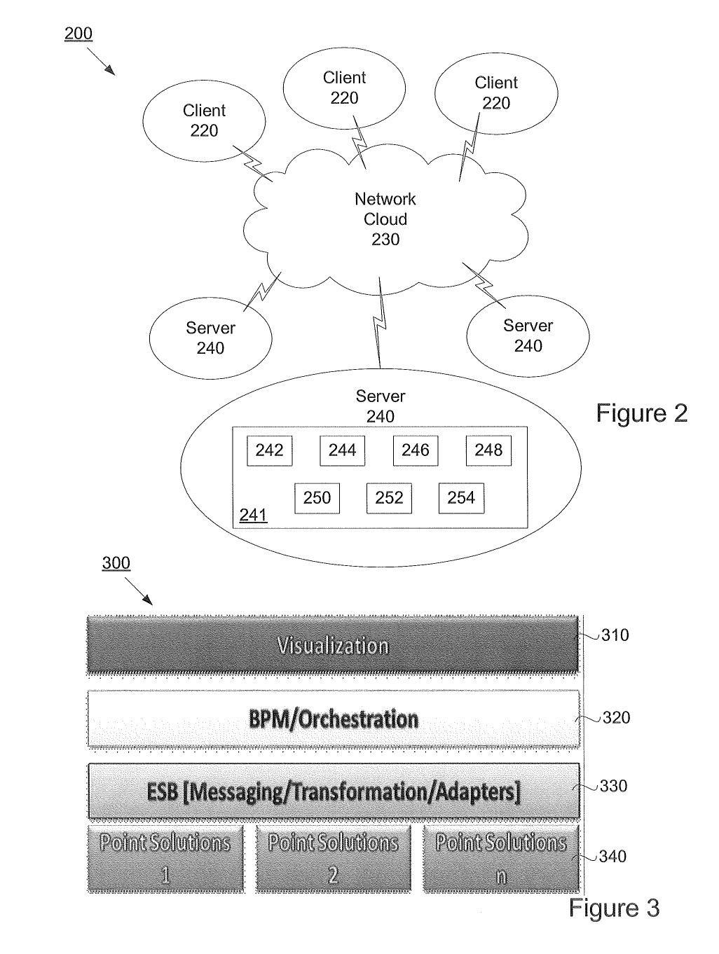

FIG. 2 shows a cloud computing environment 200. Multiple client data processing systems 220 communicate over network cloud 230 to multiple server data processing systems 240. Each of the client data processing systems 220 and server data processing systems 240 can be implemented as a data processing system 100, further configured as described herein. One of the server data processing systems 240 is shown in more detail, and also includes an IDE 241 including various core components that provide support for purposes of development, including a scheduling engine 242, a remote/local runtime engine 244, a messaging engine 246, an event engine 248, an integration engine 250, a UI engine 252, and a workflow engine 254. The IDE and its components can be implemented as special-purpose controllers, or as a processor 102 configured to function as the IDE described herein

In various embodiments, the IDE facilitates the utilization of restricted programming concepts that empowers developers to utilize cloud, enhances a limited set of core functionalities, and provides constructs that can be built on top of Data Center Markup Language (DCML) for hosting platforms based on how the platforms are be provisioned.

FIG. 3 depicts a Composite Application Framework (CAF) 300. In various embodiments, the IDE provides constructs that is applicable across all the four tiers of a Composite Application Framework (CAF). Visualization tier 310 is aided by a GUI development framework that is XML-based. Business Process management (BPM) and Orchestration tier 320 is aided by variation of Business Process Execution Language (BPEL) in some embodiments, and for business process modeling, Business Process Modeling Notation (BPMN) and/or the XML Process Definition Language (XPDL) can be used. The enterprise service bus (ESB) tier 330 is enhanced by IDE functions.

Point solutions 340 can be user (custom applications) or Commercial Off the Shelf (COTS) applications or custom solutions and use the adapter development kit to create custom adapters for interfacing with point solutions.

In various embodiments, the runtime environment includes all of the above, possibly excepting the IDE, plus a facility to specify both service management and service delivery aspects. In some embodiments, the service delivery and management relates to an ITIL framework, which is metadata driven to specify runtime parameters such as high-availability, disaster recovery, how to scale, etc. These are interpreted by the engine at runtime to modify the attributes of the provisioned environment that houses the application that is deployed.

Various embodiments provide reuse of business process outsourcing (BPO), hardware, and applications across a multi-tenancy cloud system, and allow meta-data verbs to dictate the runtime hosting environment provisioning, e.g., classified/unclassified, disaster recovery and high availability, etc. Various embodiments provide a mechanism to address release and change management, and provides basic constructs provide services on both very large and small scale. The XML construct provides all the functionality required for hosting without acquiring new services for service provisioning.

In disclosed embodiments, objects are defined and created for all instances of data manipulation. A serializer then converts/translates to an XML format before it is sent as message for intermediaries. Upon receiving the message at the recipient end, the message action handler converts/translates XML message to back to the object and invokes methods within the object to perform action specified. Disclosed embodiments include both a serializer and de-serializer part of engine. These components complement each other, and this is similar to the integration server.

The IDE uses a markup language to define functions according to Expressions, Actions and Statements categories to define a programming language construct; these are created part of call-back as drag-drop from the IDE and converted back to objects to execute the commands at runtime. The lowest common denominator is statement, followed by statement, followed by action. Combination of action/statement/verb is called as task, series of tasks is referred as job and series of jobs is grouped as jobsession. This method is employed for reuse, better error handling and modular constructs. For example: On file creation on specific directory perform an action could be an example for integration from UI to COTS or custom application hosted in cloud environment. In this approach it is integration based on file creation instead of scheduled. In the integration framework, for the sake of clarity, the job engine is classified under each of the Expressions, Actions and Statements categories.

Actions: An “action” is defines as whenever one has to perform a particular operation such as copy a file or delete a file. The supported actions are: Copy, Delete, Rename, Execute, End Job, End Session, Fail, Pause, Succeed, System, Zip, and UnZip.

Various Actions are briefly described below (Unless otherwise specified all filenames are in URL format, e.g. http://):

Copy: Copy source=filename, destination=filename.

Delete: Delete source=filename

Rename: Rename source=file, destination=filename

Execute: Execute application=notepad, +others

End Job: Abruptly or conditionally End a job with failure

End Job Session: Abruptly or conditionally End a job session

Fail: Forcefully fail an action [for testing only, not implemented in job editor]

Pause: Pause x seconds

Succeed: Forcefully make an action exit with success, for testing purposes.

Zip: Zip source=filename or wildcard path, destination=filename

UnZip: UnZip source=filename, destination=path

In various embodiments, a user does not have to worry about syntax or parameters required for every action since these constructs and the XML are created from the GUI. IDE 241 is configured to create constructs and executable code as described herein through an interaction with a user using a graphical user interface. See the example described above for integration.

Adding: The following will describe adding a new action called CreateFile.

Step 1: One would create a CreateFileAction class in the Actions folder. CreateFile will be derived from ActionBase and will expose the override Run Method:

```
public class CreateFileAction derived from ActionBase
begin
  constructor CreateFileAction( )
  begin
  end
  Implement bool Run(Current Context)
  begin
    if(Parameters.ContainsKey(“Source”) == false)
      throw new ArgumentException(“Source path
    not specified”);
    //Create file here
  end
end
```

Expressions: Whenever one has to perform a particular operation, such as conditional delete or use of a dynamic variable during execution, an expression is used and evaluated. An expression factory evaluates expressions at run time. In various embodiments, the supported Expressions are: FileExists, VariableExpression, LastActionSucceeded.

Statements: A statement is used whenever one has to perform a particular operation such as conditional copy or conditional execution of a step, such as using “If then else” or “while” constructs. Statements provide a way to group and execute steps via “If—Then—Else” and “While” constructs. In disclosed embodiments, the statements include the statements described below. The syntax of statements and expressions are similar to other programming language constructs, with the exception that various embodiments use XML representation of it within the engine.

IF Statement: Allows evaluation of an expression and to group true and false steps.

```
If Expression
    <True> statements </True>
    Else
    <False> Statement </False>
End If
```

A While expression loops while the expression evaluates to true, and groups true statements or tasks together.

While <Expression>
<True>
Statements
</True>
Wend

One can combine Expressions in statements but not actions.

A Job is a collection of discrete actions, expressions, or statements, or collection of actions, expressions, and statements. A Job Session is implemented as a collection of jobs. The Job Session code is also capable of including actions, expressions and statements in a session, outside of a job. A run method is illustrated below. “Task” is used above to provide a better understanding for readers, but “Job” is also used herein. As used below, JobContext is an instance of all the variables that are at specific state during runtime execution. Get/set are properties as indicated. Critical defines whether the step is critical to the completion. Some jobs are not critical; the system may not care if there is no file when listening for file creation event)

```
public interface IAction derived from IJobStep
begin
    StringDictionary Parameters{get;}
    bool IsCritical{get;set;}
    string Type{get;set;}
    void Initialize(StringDictionary Parameters);
    Implement bool Run(CurrentRun Context);
end
```

All actions are derived from ActionBase. Action base implements IAction and abstracts the Run Method. Therefore, the derived class should implement the Run method. ActionBase implements a handful of public methods so that the derived classes do not need to implement them, unless it needs to override those methods:

```
public abstract class ActionBase : IAction
    begin
        private StringDictionary m_parms = null;
        private bool m_isCritical = true;
        private string m_type = “”;
        private string m_stepID =
Guid.NewGuid( ).ToString( );//default to a unique number
        private bool m_hasExecuted = false;
        constructor ActionBase( )
    begin
    end
    public abstract bool Run(JobContext Context);
end
```

As illustrated above, all derived Actions only have to implement the Run Method, since it is abstracted, otherwise the compiler will not compile the new action. One simple action. FailAction, is illustrated below:

```
public class FailAction : ActionBase
    begin
        constructor FailAction( )
        begin
        end
        Implement bool Run(JobContext Context)
        begin
            return false;
        end
    end
```

Adapter specifications for creating custom adapters are interface based so writing adapters is very simple. A sample XML construct for Visualization (Similar to XAML) is illustrated below:

<?xml version=″1.0″ encoding=″utf-8″ ?>
<Window id=″{853E3222-F50D-487e-966A-F601F3978BD1}″
name=”Hello World” Position=”” >
<Control id=”{GUID}” name=”OK“ Callback=”OKcallback”>
</Control>
<Control id=”{GUID}” name=”Cancel “
Callback=”CancelCallback”>
</Control>
</Window>

A sample XML construct for BPM/Orchestration is illustrated below: StepID is a sequencer that indicates in what order to execute the jobs or statements depending on the context. Other XML fragments indicated by the exemplary code below will be understood by those of skill in the art, or is not essential for an understanding of the claimed inventions.

```
<?xml version=″1.0″ encoding=″utf-8″ ?>
<JobSession id=″{853E3222-F50D-487e-966A-F601F3978BD1}″
  name=″POS File″ type=”orchestration” retrycount=″5″
  retryinterval=″PT10M″ sendnotifications=″true″
  enabled=″true″>
  <Job id=”{345A4B67-6555-456a-8525-847CED132459}″ name=
  ″Init Vars″ effectivestart=″2004-06-09T16:05:20.6730124-05:00″
  effectiveend=″2005-06-09T16:05:20.9541156-05:00″
  timewindowstart=″PT16H30M0S″ timewindowend=″PT18H30M0S″
  isTransient=″false″ stepid=″1″ enabled=″true″>
  <Variable name=″RootDirectory″ type=″string″ stepid=″1″/>
  <Set name=″RootDirectory″ value=″C:″ stepid=″2″/>
  <Variable name=″ServerName″ type=″string″ stepid=″3″/>
  <Set name=″ ServerName ″ value=″12345″ stepid=″4″/>
  </Job>
  <Job id=″{292D4B67-6555-456a-8525-847CED131889}″ name=
  ″Move POS files″ effectivestart=″2004-06-09T16:05:20.6730124-
  05:00″ effectiveend=″2005-06-09T16:05:20.9541156-05:00″
  timewindowstart=″PT16H30M0S″ timewindowend=″PT18H30M0S″
  isTransient=″false″ stepid=″2″ enabled=″true″>
    <Action type=″Execute″ service=″url″ workingdir=″url″
  arguments=″args″ waitforexit=″true″ timeout=″10″
  killaftertimeout=″true″ saveexitcode=″ExitCode″
  stepid=″6″/>
  </Jobid>
  <Job id=″{292D4B67-6555-456a-8525-847CED131889}″ name=
  ″Move POS files″ effectivestart=″2004-06-09T16:05:20.6730124-
  05:00″ effectiveend=″2005-06-09T16:05:20.9541156-05:00″
  timewindowstart=″PT16H30M0S″ timewindowend=″PT18H30M0S″
  isTransient=″false″ stepid=″2″ enabled=″true″>
    <Action type=″Execute″ service=″url″ type=”workflow”
  workingdir=″url″ arguments=″args″ waitforexit=″true″
  timeout=″10″ killaftertimeout=″true″
  saveexitcode=″ExitCode″ stepid=″6″/>
  </Jobid>
</JobSession>
```

A sample XML construct for ESB/Integration is illustrated below:

```
<?xml version=“1.0” encoding=“utf-8” ?>
<JobSession id=“{853E3222-F50D-487e-966A-F601F3978BD1}” name=
    “POS File” retrycount=“5” retryinterval=“PT10M”
    sendnotifications=“true” enabled=“true”>
    <Job id=”{345A4B67-6555-456a-8525-847CED132459}” name=
    “Init Vars” effectivestart=“2004-06-09T16:05:20.6730124-05:00”
    effectiveend=“2005-06-09T16:05:20.9541156-05:00”
    timewindowstart=“PT16H30M0S” timewindowend=“PT18H30M0S”
    isTransient=“false” stepid=“1” enabled=“true”>
    <Variable name=“RootDirectory” type=“string” stepid=“1”/>
    <Set name=“RootDirectory” value=“C:” stepid=“2”/>
    <Variable name=“ ServerName ” type=“string” stepid=“3”/>
    <Set name=“ ServerName ” value=“12345” stepid=“4”/>
    </Job>
    <Job id=“{292D4B67-6555-456a-8525-847CED131889}” name=
    “Move POS files” effectivestart=“2004-06-09T16:05:20.6730124-
    05:00” effectiveend=“2005-06-09T16:05:20.9541156-05:00”
    timewindowstart=“PT16H30M0S” timewindowend=“PT18H30M0S”
    isTransient=“false” stepid=“2” enabled=“true”>
        <Action type=“Execute”
    application=“C:\windows\notepad.exe” workingdir=“C:\”
    arguments=“$(RootDirectory)\JobInput.txt”
    waitforexit=“true” timeout=“10” killaftertimeout=“true”
    saveexitcode=“NotepadExitCode” stepid=“6”/>
        <Action type=“Copy”
    source=“$(RootDirectory)\JobInput.txt” iscritical=“true”
    destination=“$(RootDirectory)\$(Job:MachineName)temp.txt”
    stepid=“7”/>
        <If expression=“LastActionSucceeded” stepid=“8”>
            <True>
                <If expression=“FileExists”
    path=“$(RootDirectory)\$(Job:MachineName)temp.txt”
    stepid=“9”>
                    <True>
                        <Action type=“Copy”
    iscritical=“true”
    source=“$(RootDirectory)\$(Job:MachineName)temp.txt”
    destination=“$(RootDirectory)\success.txt” throttle=“180”
    stepid=“10”/>
                    </True>
                    <False>
                        <Action type=“Copy”
    source=“$(RootDirectory)\base.txt”
    destination=“$(RootDirectory)\fail.txt” stepid=“11”/>
                    </False>
                </If>
            </True>
        </If>
        <While expression=“!FileExists”
    path=“$(RootDirectory)\temp3.txt” stepid=“12”>
            <Action type=“Pause” iscritical=“true”
    time=“10” stepid=“13”/>
        </While>
        <Action type=“Copy”
    source=“$(RootDirectory)\temp3.txt”
    destination=“$(RootDirectory)\temp3_found.txt”
    iscritical=“true” stepid=“14”/>
    </Job>
    <Job id=“{F4751CE9-C941-46ba-A5B0-CBCA0CC44316}”
    name=“Cleanup” effectivestart=“2004-06-09T16:05:20.6730124-
    05:00” effectiveend=“2005-06-09T16:05:20.9541156-05:00”
    timewindowstart=“PT16H30M0S” timewindowend=“PT18H30M0S”
    sendnotifications=“false” isTransient=“false” stepid=“15”
    enabled=“false”>
        <Action type=“Delete”
    source=“$(RootDirectory)\temp3.txt”
    destination=“$(RootDirectory)\temp3_found.txt”
    iscritical=“false” stepid=“16”/>
        <Action type=“Delete”
    source=“$(RootDirectory)\success.txt” iscritical=“false”
    stepid=“17”/>
        <Action type=“Delete”
    source=“$(RootDirectory)\fail.txt” iscritical=“false”
    stepid=“18”/>
        <Action type=“Delete”
    source=“$(RootDirectory)\temp.txt” iscritical=“false”
    stepid=“19”/>
    </Job>
</JobSession>
```

A sample XML construct for Messaging is illustrated below:

```
<?xml version=“1.0” encoding=“utf-8” ?>
<Broadcast saveresult4shell=“true” saveresult=“true”>
        <Group>nodes</Group>
        <Server> ServerName </Server>
        <Method>RemoveJob</ Method>
        <Webreference>Reference of web service</
    Webreference>
        <Message>
            <RemoveJob>
        ....  <- Delete Job specifics (<Job id=‘guid’
    />)
            </RemoveJob>
        </Message>
</Broadcast>
```

A sample XML construct for Scheduling, in accordance with disclosed embodiments, is illustrated below:

```
<?xml version=“1.0” encoding=“utf-8” ?>
<ScheduledTasks>
    <Task id=“{08340AF5-13B8-4e47-9C16-E7B6315CB0DE}” name=
    “POS Daily Upload Session” comments=“Uploads pos files to host”
    applicationpath=“jobexec.exe”
    parameters=“/sessionid:{1234341341343}” workingdir=“C:\”
    limitruntime=“false” maxruntime=“10000” priority=“1”
    account=“domain\username” password=“somepassword”>
        <!-- This is a daily schedule that will run at 10:30
    am every 1 day -->
        <DailySchedule id=“{D4AD4E3F-1602-4ede-8C44-
    630F4109F2A5}” startdate=“2004-09-09T15:49:12.2365216-
    05:00” enddate=“2004-09-23T15:49:12.7572704-05:00”
    beginhour=“10” beginminute=“30” dayinterval=“1” />
        <!-- This is a weekly schedule that will run at 8:00
    am every 2 weeks on Mondays, Wednesdays and Saturdays.
            The “dayofweekmask” attribute is a bit mask
    containing the days of the week
            Bits  76543210
                    01001010 Is equal to decimal 74
                    |||||||Sunday
```

| | |
|---|---|
| \|\|\|\|\|\|Monday | (is set to 1) |
| \|\|\|\|\|Tuesday | |
| \|\|\|\|Wednesday | (is set to 1) |
| \|\|\|Thursday | |
| \|\|Friday | |
| \|Saturday | (is set to 1) |

```
                    Ignored
        -->
        <WeeklySchedule id=“{432E2980-A2BB-4835-B461-
    B980980F6704}” startdate=“2004-09-09T15:49:12.2365216-
    05:00” enddate=“2004-09-23T15:49:12.7572704-05:00”
    beginhour=“8” beginminute=“0” weekinterval=“1”
    dayofweekmask=“74” />
        <!-- This is a monthly schedule. Both the
    “monthsmask” and “daysmask” attributes are bit masks. The
    monthsmask value is a short integer (ie 2 bytes or 16 bits)
    mask, and the days of month mask is an integer (ie 32 bits)
    mask.
            Month Mask
            Bits  111111
                    5432109876543210
                    0000010001010001
                    |||||||||||||||January
                    ||||||||||||||February
                    |||||||||||||March
                    ||||||||||||April
                    |||||||||||May
                    ||||||||||June
                    |||||||||July
                    ||||||||August
                    |||||||September
                    ||||||October
                    |||||November
                    ||||December
                    |||Ignored
                    ||Ignored
                    |Ignored
                    Ignored
            Each bit index will represent the day of the
    month. Because there are at most 31 days in a month a 32
    bit integer works perfectly.  So, if one wanted to run a
    schedule on the 4, 8, 16, 23, and 29 day of the month, one
    would set a bit mask as so
            Day of Month Mask
            Bits  3322222222221111111111
                    10987654321098765432109876543210
                    00100000100000010000000100010000
            Translating that bit pattern to decimal yields
    a decimal value of 2130177.  So if we wanted to build a
    monthly schedule that ran only on January, May, July
    November, on the 1 and 15 of each month at 6:45 pm
        -->
        <MonthlySchedule id=“{6C46E0DC-C35B-42a8-AD69-
    0349C0A4F8F7}” startdate=“2004-09-09T15:49:12.2365216-
    05:00” enddate=“2004-09-23T15:49:12.7572704-05:00”
    beginhour=“16” beginminute=“45” monthsmask=“1105”
    dayofmonthmask=“32770” />
    </Task>
</ScheduledTasks>
```

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A data processing system comprising a processor and accessible memory, the data processing system implementing an integrated development engine configured to automatically create and provision a computing environment in a network cloud environment.

2. The data processing system of claim 1, wherein the integrated development engine interacts with a user via a graphical user interface to create applications for the network cloud environment.

3. The data processing system of claim 1, wherein the integrated development engine includes a scheduling engine.

4. The data processing system of claim 1, wherein the integrated development engine includes a remote/local runtime engine.

5. The data processing system of claim 1, wherein the integrated development engine includes a messaging engine.

6. The data processing system of claim 1, wherein the integrated development engine includes an event engine.

7. The data processing system of claim 1, wherein the integrated development engine includes an integration engine.

8. The data processing system of claim 1, wherein the integrated development engine includes a user interface engine, and a workflow engine.

9. The data processing system of claim 1, wherein the integrated development engine includes a workflow engine.

10. The data processing system of claim 1, wherein the integrated development engine uses a markup language to define functions according to Expressions, Actions and Statements categories.

11. The data processing system of claim 11, wherein a job engine is classified under each of the Expressions, Actions and Statements categories.
